(19) United States
(12) Patent Application Publication
(10) Pub. No.: US 2020/0130692 A1
(43) Pub. Date: Apr. 30, 2020

(54) STEADY STATE CONTROL OF MODEL PREDICTIVE CONTROL BASED POWERTRAIN WITH CONTINUOUSLY VARIABLE TRANSMISSION

(71) Applicant: GM Global Technology Operations LLC, Detroit, MI (US)

(72) Inventors: Michael Livshiz, Ann Arbor, MI (US); Bharath Pattipati, South Lyon, MI (US); Michael T. Sarzynski, Royal Oak, MI (US); Jean-Christian Cousin, Ann Arbor, MI (US)

(21) Appl. No.: 16/174,670

(22) Filed: Oct. 30, 2018

(51) Int. Cl. B60W 30/188

(52) U.S. Cl. CPC B60W 30/188; B60W 2720/30; B60W 2510/0657; B60W 2510/1005; B60W 2520/30

(57) ABSTRACT

A method for controlling a propulsion system of a motor vehicle includes: optimizing both torque control and fuel economy during transient operating conditions; performing a steady state control enable function to identify when steady state operating conditions are present including: determining a commanded axle torque; obtaining a measured actual axle torque; and identifying when the commanded axle torque is substantially equal to the measured actual axle torque and outputting a signal; and further includes: directing the signal output from the control enable function to each of an integral action calculator and a Ym filter; performing an integral action calculation to identify an axle torque integral action; and setting a steady state flag when steady state operating conditions are present which fixes system variables directed to optimizing torque control, temporarily ceasing further optimization of torque control when the steady state flag is set.

### INTRODUCTION

The disclosure relates to a control system and method for a propulsion system of a motor vehicle having an engine and a transmission, and more particularly to a control system and method that uses a multivariable controller.

Propulsion system control in a motor vehicle generally involves reading driver and vehicle inputs, such as accelerator pedal position, vehicle sensor data, and torque requests, and communicating these inputs to an Engine Control Module (ECM) and a Transmission Control Module (TCM). The ECM may calculate a desired axle torque from the driver and vehicle inputs. The desired axle torque may then communicated to the engine and to the TCM. The engine is controlled based on the desired axle torque to produce an actual axle torque. Meanwhile, the ECM calculates a desired speed or gear ratio from the desired axle torque and the vehicle speed. The desired gear ratio is then communicated to the transmission. The transmission is controlled based on the desired gear ratio to produce an actual gear ratio. The actual axle torque and the actual gear ratio define the operating conditions of the motor vehicle.

Engine control systems have been developed to control engine output torque to achieve a desired torque. Traditional engine control systems, however, do not control the engine output torque as accurately as desired. In particular torque oscillations which occur during steady state operating conditions reduce fuel economy and effect torque command signals.

While this system of propulsion system control is useful for its intended purpose, there is room in the art for improvements that provide dynamic control of the axle torque to balance performance and fuel economy, especially in propulsion systems having a continuously variable transmission.

### SUMMARY

According to several aspects, a method for controlling a propulsion system of a motor vehicle includes: performing a steady state control enable function to identify when steady state operating conditions are present including: determining a commanded axle torque; obtaining a measured actual axle torque; and identifying when the commanded axle torque is substantially equal to the measured actual axle torque and outputting a signal. The method further includes: directing the signal output from the control enable function to each of an integral action calculator and a Ym filter; and performing an integral action calculation to identify an axle torque integral action.

In another aspect of the present disclosure, wherein performing the integral action includes: calculating an absolute value of a difference obtained by subtracting the measured actual axle torque from the commanded axle torque; and filtering the absolute value to minimize signal deviations.

In another aspect of the present disclosure, the method further includes: performing a hysteresis evaluation of the filtered absolute value; and comparing an output from the hysteresis evaluation to a predetermined calibration limit range saved in a memory to determine if the commanded axle torque is within a calibration limit range.

In another aspect of the present disclosure, the method further includes initiating a delay timer if the commanded axle torque is within the predetermined calibrated limit range.

In another aspect of the present disclosure, the integral action calculator performs the following steps: subtracting an axle torque reference value from the commanded axle torque to compute an error value; multiplying the error value together with a sampling time value to obtain a product; and adding the product to a previous value of the integral action to obtain a sum.

In another aspect of the present disclosure, the method further includes passing the sum through a limiter to identify each of an axle torque maximum limit and an axle torque minimum limit.

In another aspect of the present disclosure, the method further includes entering the axle torque maximum limit and the axle torque minimum limit into an integral action enable switch to generate an axle torque integral action command.

In another aspect of the present disclosure, the method further includes applying an output of the Ym filter to modify tracked values including a measured fuel consumption rate, an axle torque measured, a measured transmission ratio and a measured engine output torque.

In another aspect of the present disclosure, the method further includes: subtracting the measured actual axle torque from the commanded axle torque to determine an absolute error; passing an absolute error signal through a low-pass filter to filter predetermined deviations from the signal; determining if the absolute error signal is less than a predetermined first calibration value; determining if the commanded axle torque signal is greater than a predetermined second calibration value; and initiating a delay timer if both the absolute error signal is less than the predetermined first calibration value and if the commanded axle torque signal is greater than the predetermined second calibration value.

In another aspect of the present disclosure, the method further includes: determining if the delay timer has operated for a time period greater than a predetermined third calibration value; and setting a steady state flag if the delay timer has operated for the time period greater than the predetermined third calibration value.

According to several aspects, a method for controlling a propulsion system of a motor vehicle includes: performing a control enable function including: determining a commanded axle torque; obtaining a measured actual axle torque; calculating an absolute value of a difference obtained by subtracting the measured actual axle torque from the commanded axle torque; filtering the absolute value to minimize signal deviations; performing a hysteresis evaluation of the filtered absolute value; comparing an output from the hysteresis evaluation to a predetermined calibration limit range saved in a memory to determine if the commanded axle torque is within a calibration limit range; and initiating a delay timer if the commanded axle torque is within the predetermined calibrated limit range; directing a signal output from the control enable function to each of an integral action calculator and a Ym filter; and outputting an integral action range enable command after a predetermined time period.

In another aspect of the present disclosure, the method further includes: performing the control enable function using the following set of equations: Tₐₑ (k)=|Tₐᵣ (k)−Tₐ (k)|; and Tₐₑ (k)=Tₐₑ (k−1)+α {Tₐₑ (k)−Tₐₑ (k−1)} where: Tₐᵣ=Driver axle torque request; Tₐ=Actual axle torquep Tₐₑ=Axle torque absolute error; α=Low-pass filter coefficient; and k=Discrete-time step.

In another aspect of the present disclosure, the method further includes performing the control enable function using the following additional set of equations: IF: {Tₐₑ (k)<=LSP&& Tₐᵣ (k)>=Aᵤ &&DT(k)>=t_{d}}→I_{E}(k)=1; ELSEIF: {Tₐₑ (k)>=RSP∥ Tₐᵣ(k)<=Aₗ}−I_{E}(k)=0; and ELSE: I_{E}(k)=I_{E} (k−1); where: Tₐᵣ=Driver axle torque request; Tₐₑ=Axle torque absolute error; RSP=Right-shift point; LSP=Left-shift point; Aᵤ=Axle torque upper limit; Aₗ=Axle torque lower limit; I_{E}=Integral action enable; k=Discrete-time step; and DT=turn-on delay timer.

In another aspect of the present disclosure, the integral action calculator performs an integral action using the following set of equations: Tₑ (k)=Tₐᵣ (k)−Tₐ (k); Tᵢₐ (k)=Tₑ (k)× Δk+Tᵢₐ (k−1); and Tᵢₐₘᵢₙ<=Tᵢₐ (k)<=Tᵢₐₘₐₓ; where: Tₐᵣ=Driver axle torque request; Tₐ=Actual axle torque; Tₑ=Axle torque error; k=Discrete-time step; Δk=Sample time; Tᵢₐ=Axle torque integral action; Tᵢₐₘᵢₙ−Integral action minimum; Tᵢₐₘₐₓ=Integral action maximum.

In another aspect of the present disclosure, the integral action calculator performs the integral action using the following additional set of equations: IF: {I_{E} (k)=0∥ Cₜ}→T_{iaf} (k)=0; and ELSE: T_{iaf} (k)=Tᵢₐ (k); where: I_{E}=Integral action enable; k=Discrete-time step; Tᵢₐ=Axle torque integral action; T_{iaf}=Integral action final; and Cₜ=Controller transitions.

In another aspect of the present disclosure, the method further includes identifying when the commanded axle torque is substantially equal to the measured actual axle torque defining a steady state operating condition.

In another aspect of the present disclosure, the method further includes setting a steady state flag which fixes system variables directed to torque control changes, thereby ceasing further optimization of torque control allowing fuel economy to be maximized.

According to several aspects, a system for controlling a propulsion system of a motor vehicle includes a steady state control enable function identifying when steady state operating conditions are present using each of a commanded axle torque and a measured actual axle torque. A signal is output when the commanded axle torque is substantially equal to the measured actual axle torque. An integral action calculator and a Ym filter receive the signal output from the control enable function. An integral action calculation identifies an axle torque integral action. A steady state flag is set when steady state operating conditions are present which fixes system variables directed to optimizing torque control, temporarily ceasing further optimization of torque control after the steady state flag is set.

In another aspect of the present disclosure, the system further includes a delay timer initiated if the commanded axle torque is within a predetermined calibrated limit range.

In another aspect of the present disclosure, the steady state flag is also set if the delay timer has operated for a time period greater than a predetermined calibration value.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a motor vehicle having an exemplary propulsion system, in accordance with the principles of the present disclosure;

FIG. 2 is a schematic diagram showing a propulsion control system for use with the propulsion system shown in FIG. 1, according to the principles of the present disclosure;

FIG. 3 is a schematic diagram of a control system for use with the propulsion control system shown in FIG. 2, in accordance with the principles of the present disclosure;

FIG. 4 is a schematic diagram illustrating additional details of the control system shown in FIG. 3, according to the principles of the present disclosure;

FIG. 5 is a schematic diagram illustrating additional details of a multivariable controller of the control system shown in FIGS. 3-4, in accordance with the principles of the present disclosure;

FIG. 6 is a block diagram illustrating additional details of the control system shown in FIG. 5, in accordance with the principles of the present disclosure;

FIG. 7 is a block diagram defining steps of a steady state control enable function, according to the principles of the present disclosure;

FIG. 8 is a block diagram defining steps of an integral action calculation, according to the principles of the present disclosure; and

FIG. 9 is a block diagram illustrating a method for setting and clearing steady state flags, according to the principles of the present disclosure.

### DETAILED DESCRIPTION

The following description is merely exemplary in nature and is not intended to limit the present disclosure, application, or uses.

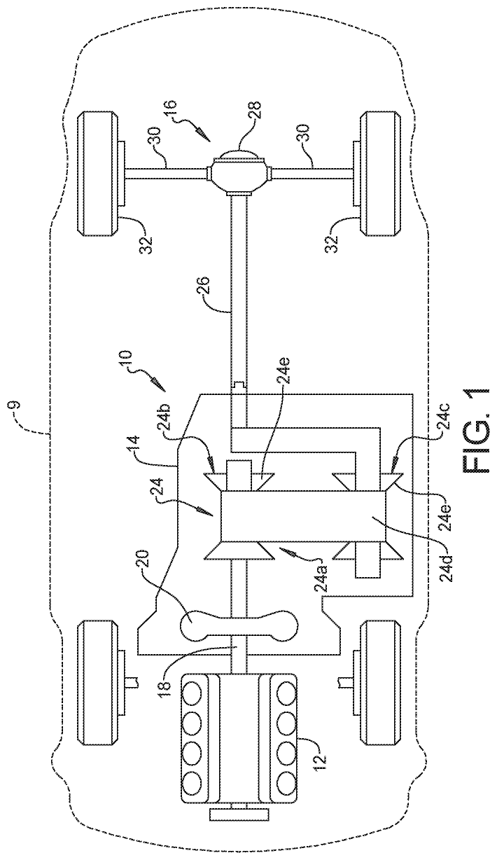

Referring to FIG. 1, an exemplary motor vehicle is shown and generally indicated by reference number 9. The motor vehicle 9 is illustrated as a passenger car, but it should be appreciated that the motor vehicle 9 may be any type of vehicle, such as a truck, van, sport-utility vehicle, etc. The motor vehicle 9 includes an exemplary propulsion system 10. It should be appreciated at the outset that while a rear-wheel drive propulsion system 10 has been illustrated, the motor vehicle 9 may have a front-wheel drive propulsion system without departing from the scope of the present disclosure.

The propulsion system 10 generally includes an engine 12 interconnected with a transmission 14 and a final drive unit 16. The engine 12 may be a conventional internal combustion engine or an electric engine, hybrid engine, or any other type of prime mover, without departing from the spirit and scope of the present disclosure. The engine 12 supplies a driving engine output torque to the transmission 14 via a crankshaft or engine output shaft 18. The driving engine output torque may be transmitted through a flexplate and/or starting device 20 to the transmission 14. The starting device 20 may be a hydrodynamic device, such as a fluid coupling or torque converter, a wet dual clutch, or an electric motor, by way of example. Torque is then transmitted from the starting device 20 to at least one transmission input shaft 22.

The transmission 14 may be a stepped transmission having planetary gears, a countershaft transmission, a continuously variable transmission, or an infinitely variable transmission. Torque from the transmission input shaft 22 is communicated through a ratio control unit 24 to a transmission output shaft 26. Generally, the ratio control unit 24 provides a plurality of forward or reverse speed or gear ratios, or an infinite number of forward or reverse speed or gear ratios, between the transmission input shaft 22 and the transmission output shaft 26.

Where the transmission 14 is a continuously variable transmission, the ratio control unit 24 may include a variator assembly 24a having first and second pulleys 24b, 24c that are rotatably coupled by an endless rotatable member 24d wrapped around the variable diameter pulleys 24b, 24c. At least one of the first and second pulleys 24b, 24c includes a movable sheave 24e translatable along an axis to selectively change a gear ratio between the engine output shaft 18 and the transmission output shaft 26.

The transmission output shaft 26 communicates output torque to the final drive unit 16. The final drive unit 16 generally includes a differential 28 that transfers axle torque through drive axles 30 to drive wheels 32.

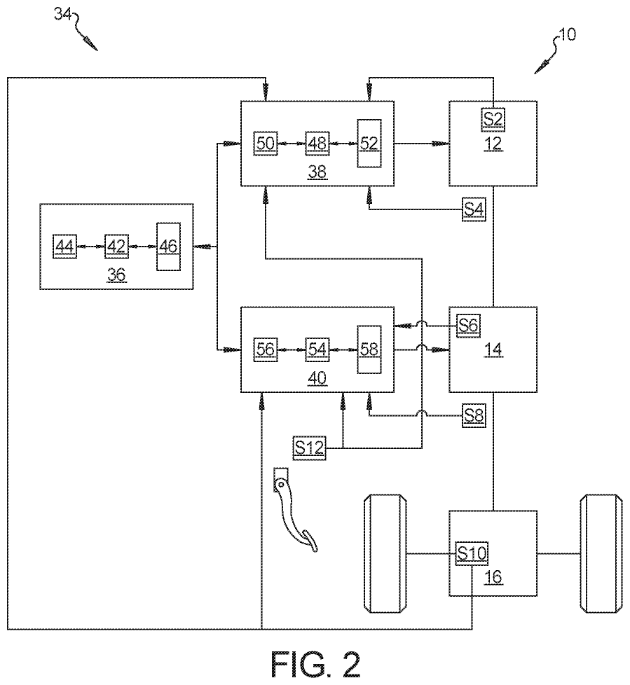

Referring to FIG. 2 and again to FIG. 1, model predictive control (MPC) processes are applied. MPC defines a method to control a process while satisfying a set of constraints. Model predictive control processes rely on dynamic models of the process, most often linear empirical models. One advantage of an MPC system is it allows a current process time interval to be optimized, while also accounting for future time intervals. This is achieved by optimizing a finite time period, but only implementing the current time interval and then optimizing again, repeatedly. MPC also has the ability to anticipate future events and can take control actions accordingly.

Referring to FIG. 2, a vehicle propulsion control system for use with the exemplary propulsion system 10 is generally indicated by reference number 34. The vehicle propulsion control system 34 includes a supervisory control module 36 in electronic communication with an engine control module 38 and a transmission control module 40. The modules 36, 38, and 40 may communicate through a vehicle network or cable area network (CAN) bus. The vehicle propulsion control system 34 may include or communicate with various other control modules, such as a body control module or infotainment control module. Alternatively, the supervisory control module 36 may be subsumed within the engine control module 38 or transmission control module 40.

The supervisory control module 36 is a non-generalized, electronic control device having a preprogrammed digital computer or processor 42, memory or non-transitory computer readable medium 44 used to store data such as control logic, instructions, image data, lookup tables, etc., and a plurality of input/output peripherals or ports 46. The processor 42 is configured to execute the control logic or instructions.

The engine control module 38 is a non-generalized, electronic control device having a preprogrammed digital computer or processor 48, memory or non-transitory computer readable medium 50 used to store data such as control logic, instructions, image data, lookup tables, etc., and a plurality of input/output peripherals or ports 52. The processor 48 is configured to execute the control logic or instructions. The engine control module 38 communicates with, and controls, the engine 12.

The transmission control module 40 is a non-generalized, electronic control device having a preprogrammed digital computer or processor 54, memory or non-transitory computer readable medium 56 used to store data such as control logic, instructions, image data, lookup tables, etc., and a plurality of input/output peripherals or ports 58. The processor 54 is configured to execute the control logic or instructions. The transmission control module 40 communicates with, and controls, the transmission 14.

The vehicle propulsion control system 34 communicates with a plurality of sensors connected to the propulsion system 10 including an air flow sensor S2 in the engine 12, an engine speed sensor S4, a transmission input shaft speed sensor S6, a transmission output shaft speed sensor S8, a vehicle speed sensor S10, and a pedal position sensor S12. The air flow sensor S2 and the engine speed sensor S4 communicate with the engine control module 38. The transmission input shaft speed sensor S6 and the transmission output shaft speed sensor S8 communicate with the transmission control module 40. The vehicle speed sensor S10 and the pedal position sensor S12 communicate with both the engine control module 38 and the transmission control module 40.

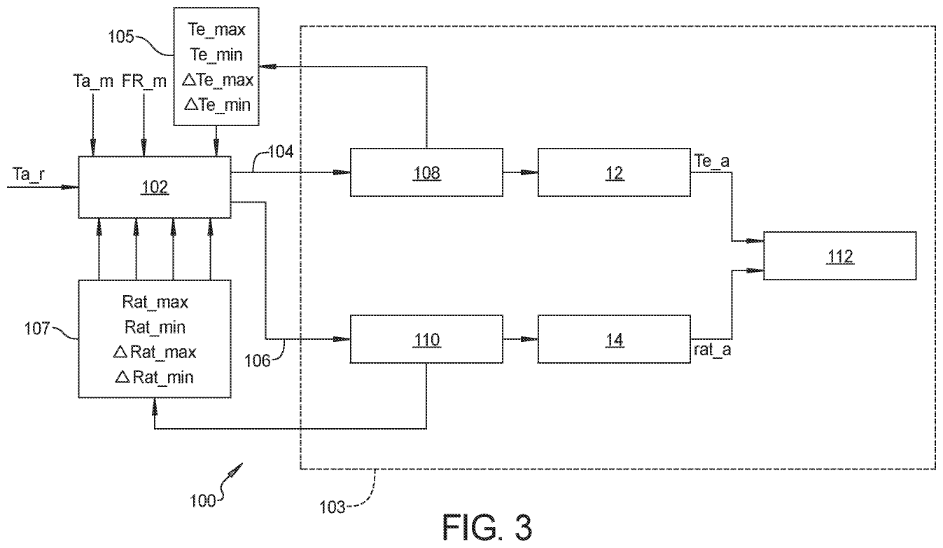

Referring to FIG. 3, and with continued reference to FIGS. 1 and 2, a control diagram for the vehicle propulsion control system 34 is illustrated. The control diagram illustrates a control system or method 100 for controlling a parameter, such as vehicle acceleration, while optimizing fuel economy, which utilizes a multivariable controller. The control system 100 includes a multivariable controller 102 and a plant 103 that is controlled by the multivariable controller 102. The multivariable controller 102 may iteratively control an engine output torque Te 104 and a transmission ratio Rat 106 to optimize a fuel consumption rate FR and to achieve a desired axle torque Ta. The axle torque Ta is the amount of torque at the vehicle axle 30. Inputs to the multivariable controller 102 include a measured actual axle torque Ta_m, a measured fuel consumption rate FR_m, and an axle torque requested Ta_r, which may be based on driver and vehicle inputs and/or an axle torque intervention, which will be discussed in further detail below.

The control system 100 may include an engine torque controller 108, a transmission ratio controller 110 (which may be a variator controller for continuously variable transmissions (CVTs)), and a vehicle dynamics module 112. In some examples, the multivariable controller 102 is stored and executed by the supervisory control module 36, the engine torque controller 108 is stored and executed by the engine control module 38, and the transmission ratio controller 110 is stored and executed by the transmission control module 40. The vehicle dynamics module 112 may be stored and executed by the engine control module 38, the transmission control module 40, or any other control module or a combination of control modules.

The multivariable controller 102 may optionally receive system limitations 105 from the engine controller 108 including a maximum engine output torque Teₘₐₓ, a minimum engine output torque Teₘᵢₙ, a maximum rate of change of engine output torque ΔTeₘₐₓ, and a minimum rate of change of engine output torque ΔTeₘᵢₙ. The multivariable controller 102 may also optionally receive system limitations 107 from the transmission ratio controller 110 including a maximum transmission ratio Ratₘₐₓ, a minimum transmission ratio Ratₘᵢₙ, a maximum rate of change of transmission ratio ΔRₘₐₓ, and a minimum rate of change of transmission ratio ΔRₘᵢₙ.

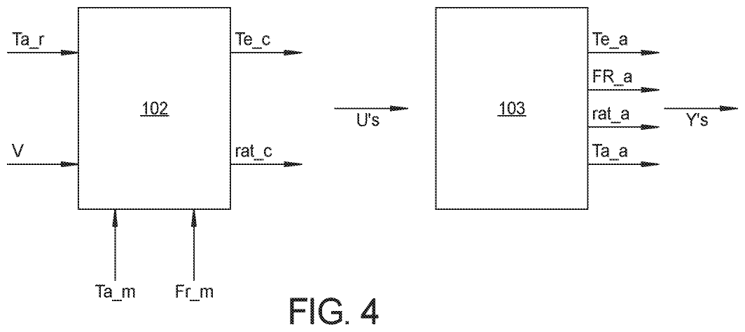

Referring now to FIG. 4, another representation of the control system 100 is illustrated, showing inputs and outputs to the multivariable controller 102 and the plant 103 controlled by the multivariable controller 102. For example, inputs to the multivariable controller 102 may include an axle torque requested Ta_r and vehicle speed V. Feedback inputs of axle torque measured Ta_m and fuel consumption rate measured FR_m may also be input to the multivariable controller 102. Outputs of the multivariable controller 102 may include an engine output torque commanded Te_c and a transmission ratio commanded Rat_c. These controlled outputs, or “u” variables (Te_c and Rat_c), of the multivariable controller 102 may be inputs to the plant 103, which includes the engine 12 and transmission 14.

The engine output torque commanded Te_c is used to control the engine 12 to result in an actual engine output torque, which is the measured engine output torque Te_m. The transmission ratio commanded Rat_c is used to control the transmission 14 to provide an actual measured gear ratio or pulley ratio Rat_m between the transmission input shaft 22 and the transmission output shaft 26. Thus, the plant 103 outputs the “y” variables, the values that may be tracked, which may include actual measured engine torque Te_m, actual measured fuel consumption rate FR_m, actual measured transmission ratio (or pulley ratio) Rat_m, and actual measured axle torque Ta_m.

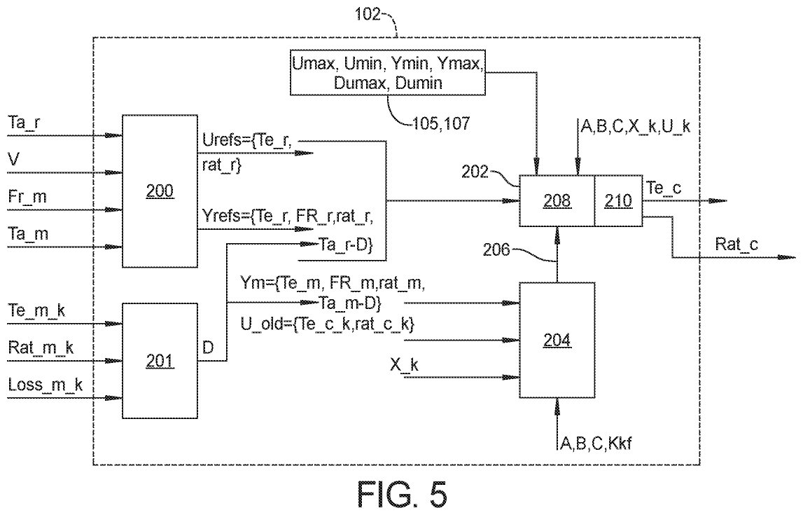

Referring now to FIG. 5, additional details of the multivariable controller 102 are illustrated. The multivariable controller 102 includes a steady state optimizer module 200, which is a reference generator. The steady state optimizer module 200 determines reference values (desired or requested values) for the “u” variables (controlled variables) and the “y” variables (the optimized output variables that may be tracked). For example, the steady state optimizer module 200 is configured to determine an engine output torque requested value Te_r, a transmission ratio requested value Rat_r, a fuel consumption rate requested value FR_r, and an axle torque requested value Ta_r. The u_{refs} include the engine output torque requested value Te_r and the transmission ratio requested value Rat_r, while the y_{refs} may include all four of the engine output torque requested value Te_r, the transmission ratio requested value Rat_r, the fuel consumption rate requested value FR_r, and the axle torque requested value Ta_r. The u_{refs} and the y_{refs} are values that are desirable during a steady state. The MPC module 202, described below, optimizes the trajectory, particularly of the fuel consumption rate, during the transient from one steady state to another.

The axle torque requested value Ta_r may be determined (e.g., in the sub-module 200C) based on the accelerator pedal position PP and the vehicle speed V. For example,

Ta_r=f(PP,V). (1)

In some examples, the axle torque requested value Ta_r may be determined from a lookup table or 2D map from a vehicle speed V sensed by vehicle speed sensor S10 and an accelerator pedal position PP sensed by the pedal position sensor S12.

The transmission ratio requested value Rat_r may be determined (e.g., in the sub-module 200B) based on the axle torque requested value Ta_r and the vehicle speed V. For example,

Rat_r=f(Ta_r,V). (2)

The engine output torque requested value Te_r may be determined (e.g., in the sub-module 200A) based on the axle torque requested value Ta_r, the transmission ratio requested value Rat_r, and the final drive ratio FD (which is constant for a given vehicle). For example,

$$Te\_r = \frac{Ta\_r + loss}{Bar mFD} \qquad ( 3 )$$

The “loss” factor may encompass mechanical losses, such as friction and pulley clamping losses, by way of example.

Minimization of fuel is achieved by minimizing engine power for requested axle power. The fuel consumption rate requested FR_r may thus be determined in any suitable way that strives to accomplish this goal. For example, the fuel consumption rate requested FR_r may be determined based on the axle torque requested Ta_r, the vehicle speed V, the engine speed RPM, and the air-fuel ratio AF. For example,

FR_r=f(Ta_r,V,RPM,AF). (4)

The engine speed RPM may be determined from the engine speed sensor S4. The air-fuel ratio AF is the ratio of the mass of air to the mass of fuel, which may be reported by a fuel control module, by way of example. In some forms, the fuel consumption rate requested value FR_r may be based on an air-per-cylinder (APC) requested value.

Once the requested values, or reference values, are determined, the steady state optimizer module 200 outputs them (the u_refs and the y_refs) to the MPC module 202. The MPC module 202 uses model predictive control and may also be referred to as a quadratic programming solver, such as a Dantzig QP solver. However, prior to using the axle torque requested value, Ta_r, in the MPC module 202, this value is linearized into a linearized torque requested value, Ta_r−D, as described further below.

A prediction module 204 is configured to predict at least an actual axle torque and an actual fuel consumption rate for use in the MPC module 202. The prediction module 204 may also be referred to as a state observer, which uses a Kalman filter. The predicted actual values 206 are output from the prediction module 204 to the MPC module 202.

The prediction module 204 is configured to generate a plurality of predicted actual axle torque values and fuel consumption rate values. For example, the prediction module generates at least a first predicted actual axle torque value and a first predicted actual fuel consumption rate value based on a first set of possible command values (which may be generated, for example, by a command generator module formed as part of the prediction module 204 or the MPC module 202), where the first set of possible command values includes a first commanded engine output torque value Te_c and a first commanded transmission ratio value Rat_c. The prediction module 204 is further configured to generate at least a second predicted actual axle torque value and a second predicted actual fuel consumption rate value based on a second set of possible command values, where the second set of possible command values includes a second commanded engine output torque value Te_c and a second commanded transmission ratio value Rat_c. In practice, a much larger number of predicted values may be generated based on additional sets of possible command values (third, fourth, fifth, etc. sets of possible Te_c and Rat_c values). The predicted actual values 206 are output to the MPC module 202.

The prediction module 204 may provide a number of predicted actual values 206 to the MPC module 202 by the cost module 208. The prediction module 204 may use equations such as the following to determine the predicted actual values 206:

$$\begin{matrix}{y}_{k} = C * {x}_{k} + w & ( 5 ) \\ {y}_{k + 1} = C * {x}_{k + 1} + w & ( 6 ) \\ {x}_{k + 1} = A * {x}_{k} + B * {u}_{k} + v + {K}_{KF} * ( {y}_{k} - {y}_{mk} ) \\ {y}_{k} = [ \begin{matrix}Te\_ {a}_{k} \\ FR\_ {a}_{k} \\ Rat\_ {a}_{k} \\ Ta\_ {a}_{k}\end{matrix} ] \\ {y}_{k + 1} = [ \begin{matrix}Te\_ {a}_{k + 1} \\ FR\_ {a}_{k + 1} \\ Rat\_ {a}_{k + 1} \\ Ta\_ {a}_{k + 1}\end{matrix} ] \\ {u}_{k} = [ \begin{matrix}Te\_ {c}_{k} \\ Rat\_ {c}_{k}\end{matrix} ] \\ {y}_{mk} = [ \begin{matrix}Te\_ {m}_{k} \\ FR\_ {m}_{k} \\ Rat\_ {m}_{k} \\ Ta\_ {m}_{k} - D\end{matrix} ] & ( 7 )\end{matrix}$$

where A=a state (or transmission) matrix; B=an input matrix; C=an output (or measured) matrix; Te_aₖ=predicted actual engine output torque at the prediction step k; FR_aₖ=predicted actual fuel consumption rate at the prediction step k; Rat_aₖ=predicted actual transmission ratio at the prediction step k; Ta_aₖ=predicted actual axle torque at the prediction step k; xₖ=state variable at a prediction step k; Te_aₖ₊₁=predicted actual engine output torque at the prediction step k+1; FR_aₖ₊₁=predicted actual fuel consumption rate at the prediction step k+1; Rat_aₖ₊₁=predicted actual transmission ratio at the prediction step k+1; Ta_aₖ₊₁=predicted actual axle torque at the prediction step k+1; xₖ₊₁=state variable at a prediction step k+1; Te_cₖ=engine output torque commanded at the prediction step k; Rat_cₖ=transmission ratio commanded at the prediction step k; K_{KF}=a Kalman filter gain (obtained by solving an algebraic Ricatti equation); Te_mₖ=measured engine output torque at the prediction step k; FR_mₖ=measured fuel consumption rate at the prediction step k; Rat_mₖ=measured transmission ratio at the prediction step k; Ta_mₖ=measured axle torque at the prediction step k; D is an estimated disturbance (which is described in further detail below); v=process noise; and w=measurement noise. The prediction step k is a prediction step at the current time (e.g., now), and the prediction step k+1 is a prediction one step ahead.

Measured engine output torque Te_m may be sensed from the engine torque sensor S4. The measured transmission ratio, or pulley ratio, Rat_m may be determined from the speed of the transmission input shaft 22 sensed by the transmission input shaft speed sensor S6 and the speed of the transmission output shaft 26 sensed by the transmission output shaft speed sensor S8 and may be provided by the TCM 40.

Ta_aₖ₊₁ and FR_aₖ₊₁ may be defined as or equal to the first predicted actual axle torque value and the first predicted actual fuel consumption rate value, respectively, when generated based on the first set of possible command values for Te_cₖ and Rat_cₖ, and Ta_aₖ₊₁ and FR_aₖ₊₁ may be defined as or equal to the second predicted actual axle torque value and the second predicted actual fuel consumption rate value, respectively, when generated based on the second set of possible command values for Te_cₖ and Rat_cₖ, and so on.

A linearization module 201 is provided in order to linearize the axle torque requested that is used by the MPC module 202. Axle torque is typically based on a nonlinear relationship between engine output torque and transmission ratio, such as shown by the following relationship:

Ta=Te*Rat*FD−Loss(RPM,Rat,Te) (8)

where Ta is axle torque, Te is engine output torque, Rat is transmission ratio, FD is the final drive ratio, and loss represents mechanical CVT losses that are a function of engine speed (RPM), transmission ratio, and engine output torque. The losses here may be the same or similar to those used in equation (3).

Such nonlinear relationship between the engine output torque and the transmission ratio with respect to the axle torque does not work well in the MPC module 202, because the predicted values determined with equations (5), (6), or (7) assume a linear relationship between the matrix variables.

Thus, to linearize the axle torque, an estimated disturbance is introduced based on a model of the measured engine output torque with respect to the measured transmission ratio. The linearization module 201 is configured to calculate the estimated disturbance so that it may be further applied within the controller.

Therefore, in one example, the linearization module 201 is configured to calculate the estimated disturbance with the following equation:

$$D = \{ \frac{( Rat\_ {m}_{k} * 100 - {Rat}_{off} ) ( Te\_ {m}_{k} - Te\_off ) FD}{100} \} - Loss ( {Rat\_m}_{k} , RPM\_ {m}_{k} , {Te\_m}_{k} ) \qquad ( 9 )$$

where D is the estimated disturbance, FD is the final drive ratio, Rat_mₖ the measured transmission ratio at a prediction step k, Rat_off is the nominal offset at which ratio model linearization was performed (e.g., Rat_off is set by ratio model linearization), Te_mₖ is the measured engine output torque at the prediction step k, Te_off is the nominal offset at which engine torque model linearization was performed (e.g. Te_off is set by engine torque model linearization, loss is a mechanical loss factor, and RPM_mₖ is a measured engine speed at the prediction step k.

The Loss input (based on the transmission ratio, the engine torque output, and the engine speed) may be stored in a lookup table for use by the linearization module 201. The final drive ratio FD is a constant for a given vehicle typically computed by multiplying axle ratio by final chain ratio. The offsets are determined in a typical calibration system identification procedure, where a model of axle torque based on certain engine output torques and transmission ratios is determined and offsets are chosen so that measured values best adhere to the model.

The estimated disturbance D may then be output from the linearization module 201 to be subtracted from both the axle torque requested Ta_r that is input to the MPC module 202 and from the axle torque measured Ta_m that is input to the prediction module 204 and used in equation (7) to determine the predicted values. Accordingly, the axle torque requested value that is used by the MPC module 202 is a linearized axle torque requested value equal to Ta_r−D. Similarly, the axle torque measured value that is used by the prediction module 204 is a linearized axle torque measured value equal to: Ta_m−D.

The MPC module 202 contains a cost module 208 that is configured to determine a first cost for the first set of possible command values Te_c, Rat_c based on at least first and second predetermined weighting values, the first predicted actual axle torque value, the first predicted actual fuel consumption rate value, the linearized axle torque requested value Ta_r−D, the engine output torque requested value Te_r, the transmission ratio requested value Rat_r, and the fuel consumption rate requested value FR_r. Similarly, the cost module 208 is configured to determine a second cost for the second set of possible command values Te_c, Rat_c based on at least the first and second predetermined weighting values, the second predicted actual axle torque, the second predicted actual fuel consumption rate value, the linearized axle torque requested value Ta_r−D, the engine output torque requested value Te_r, the transmission ratio requested value Rat_r, and the fuel consumption rate requested value FR_r. Likewise, many more additional costs may be determined based on additional sets of predicted values and command values, in order to optimize for the lowest cost.

The MPC module 202 may also include a selection module 210 configured to select one of the plurality of sets of possible command values Te_c, Rat_c based on the lowest of the determined costs and set a selected engine output torque value Te_c and a selected transmission ratio value Rat_c equal to, or based on, the possible command values Te_c, Rat_c of the selected one of the plurality of possible sets.

The selected command values Te_c and Rat_c are output from the MPC module 202 to the plant 103 (see FIGS. 3 and 4). The multivariable controller 102 or the plant 103 may contain an actuation module configured to control a vehicle parameter based on at least one of the desired (selected) command values Te_c, Rat_c. For example, acceleration of the vehicle 9 may be controlled to optimize the fuel consumption rate. In some forms, the actuation module may be contained within the vehicle dynamics module 112 shown in FIG. 3. Any vehicle system that varies an engine or transmission parameter may be referred to as an actuation module. In some forms, for example, the actuation module may vary the engine spark timing or the throttle, in order to control vehicle acceleration and/or axle torque.

The cost module 208 may be configured to determine the plurality of costs, with the following cost equation (10):

$$Cost = \sum {( y ( i \vert k ) - {y}_{ref} )}^{T} {Q}_{Y} ( y ( i \vert k ) - {y}_{ref} ) + {( u ( i \vert k ) - {u}_{ref} )}^{T} {Q}_{U} ( u ( i \vert k ) - {u}_{ref} ) + Δ {u ( i \vert k )}^{T} {Q}_{Δ u} Δ u ( i \vert k ) \\ y = [ \begin{matrix}Te\_a \\ FR\_a \\ Rat\_a \\ Ta\_a\end{matrix} ] \\ {y}_{ref} = [ \begin{matrix}Te\_r \\ FR\_r \\ Rat\_r \\ Ta\_r - D\end{matrix} ] \\ u = [ \begin{matrix}Te\_c \\ Rat\_c\end{matrix} ] \\ {u}_{ref} = [ \begin{matrix}Te\_r \\ Rat\_r\end{matrix} ] \qquad ( 10 )$$

where Te_a=predicted actual engine output torque; FR_a=predicted actual fuel consumption rate; Rat_a=predicted actual transmission ratio; Ta_a=predicted actual axle torque; Te_r=engine output torque requested; FR_r=fuel consumption rate requested; Rat_r=transmission ratio requested; Ta_r=driver axle torque requested; Te_c=commanded engine output torque; Rat_c=commanded transmission ratio; Q_{y}=a first predetermined weighting value; Qᵤ=a second predetermined weighting value; Q_{Δu}=a third predetermined weighting value; i=index value; k=prediction step; and T=transposed vector. In this case, there are two values for the “u” variables, u₁ and u₂, such that i=1, 2, and there may be four values for the “y” variables, y₁, y₂, y₃, y₄, such that i=1, 2, 3, 4. As explained above, the y_{ref} and u_{ref} values may be determined by the steady state optimizer module 200, with the linearized axle torque requested value, Ta_r−D, being determined by subtracting the disturbance D from the axle torque requested Ta_r.

The plurality of costs may be determined even more particularly with the following equation (11), which is an MPC equation having a prediction horizon of three and a control horizon of two:

Cost={λₐ*(Ta_aₖ−Ta_r−D)²+λₐ*(Ta_aₖ₊₁−Ta_r−D)²+λₐ*(Ta_aₖ₊₂−Ta_r−D)²}+{λ_{f}*(FR_aₖ−FR_r)²+λ_{f}*(FR_aₖ₊₁−FR_r)²λ_{f}*(FR_aₖ₊₂−FR_r)²}+{λₑ*(Te_cₖ−Te_r)²+λₑ*(Te_cₖ₊₁−Te_r)²}+{λᵣ*(Rat_cₖ−Rat_r)²+λᵣ*(Rat_cₖ₊₁−Rat_r)²}+{λ_{Δr}*(ΔRat_cₖ)²+λ_{Δr}*(ΔRat_cₖ₊₁)²}+{λ_{Δe}*(ΔTe_cₖ)²+λ_{Δe}*(ΔTe_cₖ₊₁)²}

where λₐ=a first predetermined weighting value; Ta_aₖ=predicted actual axle torque at a prediction step k; Ta_r=axle torque requested; D=estimated disturbance; Ta_aₖ₊₁=predicted actual axle torque at a prediction step k+1; Ta_aₖ₊₂=predicted actual axle torque at a prediction step k+2; A_{f}=a second predetermined weighting value; FR_aₖ=predicted actual fuel consumption rate at the prediction step k; FR_r=fuel consumption rate requested; FR_aₖ₊₁=predicted actual fuel consumption rate at the prediction step k+1; FR_aₖ₊₂=predicted actual fuel consumption rate at the prediction step k+2; λₑ=a third predetermined weighting value; Te_cₖ=engine output torque commanded at the prediction step k; Te_r=engine output torque requested; Te_cₖ₊₁=engine output torque commanded at the prediction step k+1; λᵣ=a fourth predetermined weighting value; Rat_cₖ=transmission ratio commanded at the prediction step k; Rat_r=transmission ratio requested; Rat_cₖ₊₁=transmission ratio commanded at the prediction step k+1; λ_{Δr}=a fifth predetermined weighting value; ΔRat_cₖ=change in transmission ratio commanded at the prediction step k; ΔRat_cₖ₊₁=change in transmission ratio commanded at the prediction step k+1; λ_{Δe}=a sixth predetermined weighting value; ΔTe_cₖ=change in engine output torque commanded at the prediction step k; and ΔTe_cₖ₊₁=change in engine output torque commanded at the prediction step k+1. The prediction step k is the prediction at a current step, the prediction step k+1 is a prediction one step ahead, and the prediction step k+2 is a prediction two steps ahead. As explained above, the y_{ref} and u_{ref} values may be determined by the steady state optimizer module 200.

The cost equation (e.g., equation (10) or (11)) may be applied iteratively to arrive at the lowest cost for a plurality of sets of possible command values Te_c, Rat_c, where the plurality of sets of possible command values Te_c, Rat_c include the first and second sets of possible command values as well as a number of other possible sets of command values for Te_c, Rat_c. Then, the selection module 210 may select the set of possible command values Te_c, Rat_c of the plurality of command values having the lowest cost, where the set of possible command values Te_c, Rat_c having the lowest cost may be defined as the selected set, including the selected transmission ratio value Rat_c and the selected engine output torque value Te_c. Similarly, the cost module 208 may generate a surface representing the cost of possible sets of command values Te_c, Rat_c. The cost module 208 and/or the selection module 210 may then identify the possible set that has the lowest cost based on the slope of the cost surface.

The cost equation (e.g., equation (10) or (11)) may be subject to the following constraints 105, 107:

Teₘᵢₙ≤Te_cₖ≤Teₘₐₓ;

Teₘᵢₙ≤Te_cₖ₊₁≤Teₘₐₓ;

Ratₘᵢₙ≤Rat_cₖ≤Ratₘₐₓ;

Ratₘᵢₙ≤Rat_cₖ₊₁≤Ratₘₐₓ;

ΔRat_cₘᵢₙ≤ΔRat_cₖ≤ΔRat_cₘₐₓ;

ΔRat_cₘᵢₙ≤ΔRat_cₖ₊₁≤ΔRat_cₘₐₓ;

ΔTe_cₘᵢₙ≤ΔTe_cₖ≤ΔTe_cₘₐₓ; and

ΔTe_cₘᵢₙ≤ΔTe_cₖ₊₁≤ΔTe_cₘₐₓ,

where Teₘᵢₙ=a minimum possible engine output torque, Teₘₐₓ=a maximum possible engine output torque, Ratₘᵢₙ=a minimum possible transmission ratio, Ratₘₐₓ=a maximum possible transmission ratio, ΔRat_cₘᵢₙ=a minimum possible rate of change in transmission ratio; ΔRat_cₘₐₓ=a maximum possible rate of change in transmission ratio, ΔTe_cₘᵢₙ=a minimum possible rate of change in engine output torque, and ΔTe_cₘₐₓ=a maximum possible rate of change in engine output torque, where the constraints 105, 107 may be provided by the ECM 38 and the TCM 40, by way of example.

The constants, matrices, and gain referred to above, including A, B, C, K_{KF}, Q_{y}, Qᵤ, Q_{Δu}, λₐ, λ_{f}, λₑ, λᵣ, λΔₑ, λΔᵣ, are parameters of the system determined through testing, physical models, or other means. In some variations, a system identification procedure is run offline, for example, during a calibration, to identify the constants, matrices, and gain, and also to define u₀ and y₀. Once u₀ and y₀ are known, then x₀ can be computed from the prediction module equations (e.g., equations (5)-(7) or a subset thereof). Thereafter, each of the prediction module 204 and MPC module 202 equations (e.g., equations (5)-(7), (10), and (11) or a subset thereof) can be run to obtain initial values offline. Then, the control system 100 can be run online to constantly optimize the controlled parameters Te_c and Rat_c as the vehicle 9 is running through steady state and transient states. The constants allow the cost to be determined based on the relationship between and relative importance of each of the commanded values Te_c, Rat_c and tracked values (e.g., FR_m, Ta_m, Rat_m, Te_m). The relationships are weighted to control the effect that each relationship has on the cost.

In some forms, the MPC module 202 may generate the possible sets of command values Te_c, Rat_c by determining possible sequences, sets, or a surface containing the command values Te_c, Rat_c that could be used for N future control loops. The prediction module 204 may determine predicted responses to the possible sets of the command values Te_c, Rat_c using the prediction module equations (e.g., equations (15)-(17) or a subset thereof). For example, the prediction module 204 may determine a set of predicted actual axle torques Ta_a and a set of predicted actual fuel consumption rates FR_a for N control loops.

More particularly, a set of N values for each command value Te_c, Rat_c may be determined, and a set of M values for each predicted actual value Ta_a, FR_a may be determined based on the N command values Te_c, Rat_c. The cost module 208 may then determine the cost value for each of the possible sets of command values Te_c, Rat_c based on the predicted actual parameters Ta_a, FR_a (which may include Ta_aₖ, Ta_aₖ₊₁, Ta_aₖ₊₂, FR_aₖ, FR_aₖ₊₁, and FR_aₖ₊₂, depending on the particular cost equation (13), (14) used). The selection module 210 may then select one of the possible sets of the command values Te_c, Rat_c based on the costs of the possible sets, respectively. For example, the selection module 210 may select the possible set of command values Te_c, Rat_c having the lowest cost while satisfying the system constraints 105, 107 (e.g., Teₘᵢₙ<Te_cₖ<Teₘₐₓ; Teₘᵢₙ<Te_cₖ₊₁<Teₘₐₓ; Ratₘᵢₙ<Rat_cₖ<Ratₘₐₓ; Ratₘᵢₙ<Rat_cₖ₊₁<Ratₘₐₓ; ΔTe_cₘᵢₙ<ΔTe_cₖ<ΔTe_cₘₐₓ; ΔTe_cₘᵢₙ<ΔTe_cₖ₊₁<ΔTe_cₘₐₓ; ΔRat_cₘᵢₙ<ΔRat_cₖ<ΔRat_cₘₐₓ; ΔRat_cₘᵢₙ<ΔRat_cₖ₊₁<ΔRat_cₘₐₓ).

In some forms, satisfaction of the constraints 105, 107 may be considered in the cost determination. For example, the cost module 208 may determine the cost values further based on the constraints 105, 107, and the selection module 210 may select the possible set of command values Te_c, Rat_c that best achieves the axle torque request Ta while minimizing fuel consumption rate FR that has been determined to comply with the constraints 105, 107.

During steady-state operation, the command values Te_c, Rat_c may settle at or near the reference, or requested, values Te_r, Rat_r, respectively. During transient operation, however, the MPC module 202 may adjust the command values Te_c, Rat_c away from the reference values Te_r, Rat_r in order to best achieve the torque request Ta_r, while minimizing the fuel consumption rate FR and satisfying the constraints 105, 107.

In operation, the MPC module 202 may determine the cost values for the possible sets of controlled and predicted values (u, y). The MPC module 202 may then select the one of the possible sets having the lowest cost. The MPC module 202 may next determine whether the selected possible set satisfies the constraints 105, 107. If so, the possible set may be defined as the selected set. If not, the MPC module 202 determines the set with the lowest cost that satisfies the constraints 105, 107 and defines that set as the selected set. The selected Rat_c command value is output from the MPC module 202 to the plant 103 (see FIG. 4).

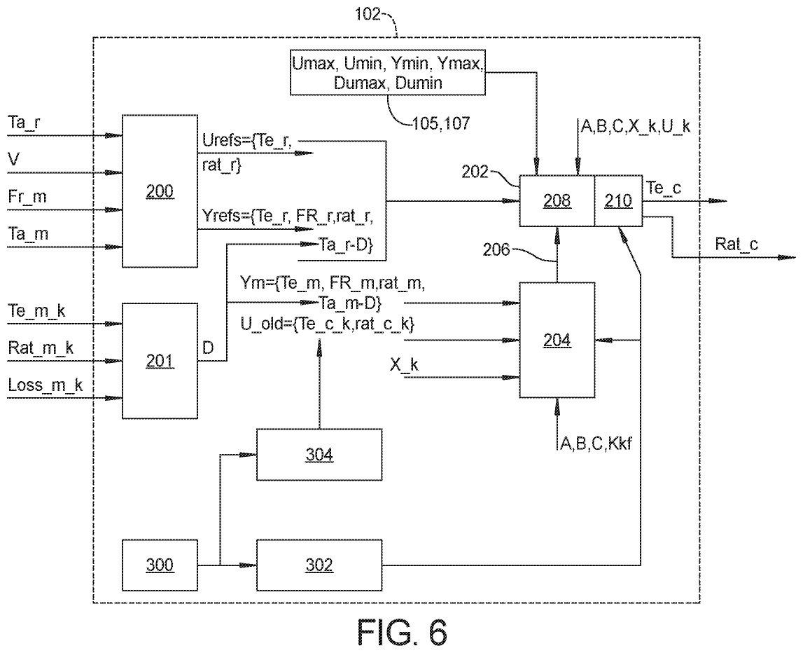

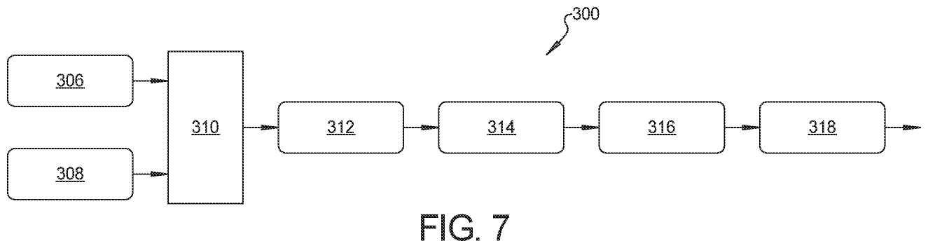

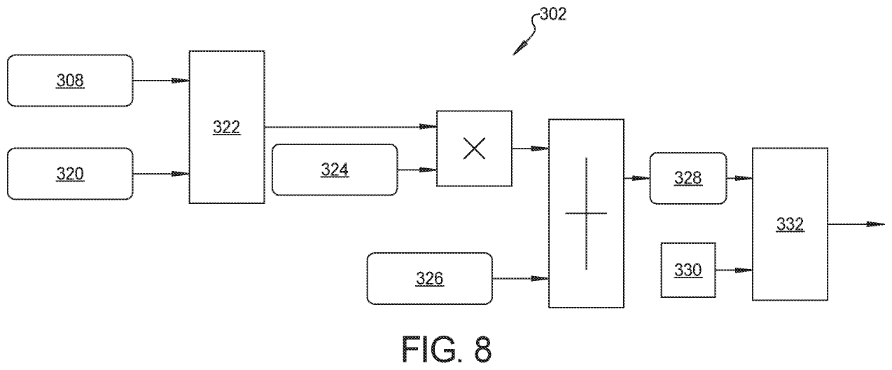

Referring to FIG. 6, during transient operation torque differences between commanded torque and actual torque may be pronounced, therefore a trade-off between axle torque response and maximizing fuel economy is optimized. Conversely, during steady state operation torque differences between commanded and actual axle torques are normally minimal. Therefore, during steady state operation it is desirable to optimize fuel economy while constraining axle torque performance. Torque oscillations which normally occur during steady state operation can result in degradation in fuel economy if the control system continues to modulate control parameters to adjust for changing torque. According to several aspects, program variables for torque control are therefore optimized to closely follow axle torque reference while minimizing fuel consumed when the actual axle torque minus the reference axle torque is less than a calibrated value such as one (1) Nm. Therefore, during steady state conditions, MPC torque control changes are optimized to maximize fuel economy while maintaining actual axle torque within calibratable constrained bounds of the reference. Steady state fuel optimization is obtained by addition of a control enable 300 function described in greater detail in reference to FIG. 7, an output of which is input to each of an integral action calculator 302 described in greater detail in reference to FIG. 8, and a Ym filter 304 such as a Kalman filter. An output of the integral action calculator 302 is input to each of the prediction module 204 and the MPC module 202. An output of the Ym filter 304 is applied to modify the tracked values (e.g., FR_m, Ta_m, Rat_m, Te_m) as inputs to the prediction module 204.

Referring to FIG. 7 and again to FIG. 6, the control enable 300 function subtracts the measured actual axle torque Ta_m 306 from the commanded or axle torque requested Ta_r 308 and determines an absolute value of the difference to identify an absolute error 310. A signal providing the absolute error 310 is passed through a low-pass filter 312 to filter predetermined deviations from the signal, and a hysteresis evaluation step 314 is then performed to prevent or minimize constraining set and unset flags. In a comparison step 316 an output from the hysteresis evaluation step 314 is compared to a predetermined calibration limit range saved in a memory or retrieved from a lookup table to determine if the commanded axle torque is within a calibration limit range. If the comparison step 316 identifies the commanded axle torque is within the predetermined calibrated limit range, an output from the comparison step 316 is input to a delay timer 318, following which an integral calculation is performed as described in reference to FIG. 8.

Control enable equations (12) and (13) for the control enable 300 function are as follows:

Tₐₑ(k)=|Tₐᵣ(k)−Tₐ(k)| (12)

Tₐₑ(k)Tₐₑ(k−1)+α{Tₐₑ(k)−Tₐₑ(k−1)} (13)

IF: {[Tₐₑ(k)<=LSP && Tₐᵣ(k)>=Aᵤ]&& DT(k)>=t_{d}}→I_{E}(k)=1

ELSEIF: {Tₐₑ(k)>=RSP∥Tₐᵣ(k)<=Aₗ}I_{E}(k)=0

ELSE: I_{E}(k)=I_{E}(k−1)

where the terms are defined as:

Driver axle torque request: Tₐᵣ

Actual axle torque: Tₐ

Axle torque absolute error: Tₐₑ

Low-pass filter coefficient: α

Right-shift point: RSP

Left-shift point: LSP

Axle torque upper limit: Aᵤ

Axle torque lower limit: Aₗ

Integral action enable: I_{E}

Discrete-time step: k

DT: turn-on delay timer

Delay time: t_{d}

Referring to FIG. 8 and again to FIG. 7, the integral action calculator 302 subtracts an axle torque reference value 320 from the axle torque requested Ta_r 308 identified in reference to FIG. 7 to compute an error value 322. The error value 322 is multiplied together with a sampling time value 324. A product defined by the error value multiplied by the sampling time value 324 is then added to a previous value of the integral. Subsequently, this sum is passed through a limiter 328. The limiter 328 identifies an axle torque maximum limit and an axle torque minimum limit. The outputs from the limiter 328 are assigned to the final integral action if the integral action enable switch 332 obtained from steps described in reference to FIG. 7 is TRUE. The final integral action is reset to zero when the integral action switch 332 goes FALSE. Consequently, this final integral action is forwarded to the prediction module 204 Kalman filter and to the QP solver of the MPC module 202 described in reference to FIGS. 5 and 6.

Integral action calculation equations (14), (15) and (16) for the integral action calculation performed by the incrementor 330 are as follows:

Tₑ(k)=Tₐᵣ(k)−Tₐ(k) (14)

Tᵢₐ(k)=Tₑ(k)×Δk+Tᵢₐ(k−1) (15)

Tᵢₐₘᵢₙ<=Tᵢₐ(k)<=Tᵢₐₘₐₓ (16)

IF: {I_{E}(k)=0∥Cₜ}→T_{iaf}(k)=0

ELSE: T_{iaf}(k)=Tᵢₐ(k)

where the terms are defined as:

Driver axle torque request: Tₐᵣ

Actual axle torque: Tₐ

Axle torque error: Tₑ

Integral action enable: I_{E}

Discrete-time step: k

Sample time: Δk

Axle torque integral action: Tᵢₐ

Integral action final: T_{iaf}

Integral action minimum: Tᵢₐₘᵢₙ

Integral action maximum: Tᵢₐₘₐₓ

Controller transitions: Cₜ

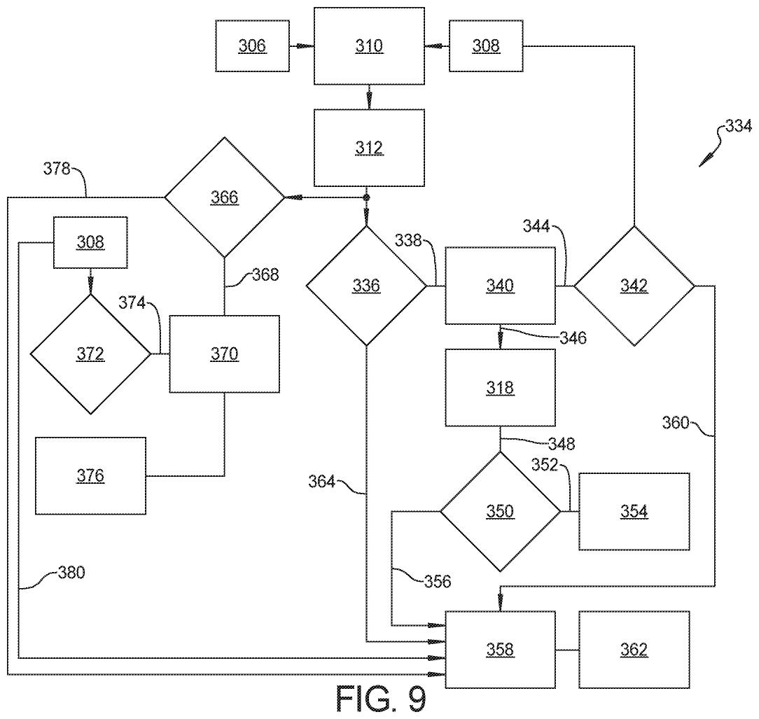

Referring to FIG. 9, when steady state conditions are identified, a flag is set which optimizes the weights of the cost function to maximize fuel economy, while maintaining the axle torque close to the reference. A steady state flag setting flow diagram 334 identifies the conditions when a steady state flag can be set and also when steady state conditions are not present. With continuing reference to FIGS. 7 and 8, the measured actual axle torque Ta_m 306 is subtracted from the commanded or axle torque requested Ta_r 308 and an absolute error 310 is determined. The absolute error 310 signal is directed through the low-pass filter 312 to filter predetermined deviations from the signal which therefor minimizes flag changes or oscillations. In a following first comparator block 336 a determination is made if the filtered absolute error 310 signal is less than a predetermined first calibration value (Cal 1) saved in a memory. If the response from the first comparator block 336 is YES, a first positive signal 338 is forwarded to an additive block 340. The additive block 340 is also in communication with a second comparator block 342 wherein a determination is made if the commanded or axle torque requested Ta_r 308 signal is greater than a predetermined second calibration value (Cal 2) saved in a memory. If the response from the second comparator block 342 is YES, a second positive signal 344 is forwarded to the additive block 340. If both positive signals are received in the additive block 340 a start timer signal 346 is forwarded to the delay timer 318.

After the delay timer 318 starts, a signal 348 is sent to initiate operation of a third comparator block 350 wherein a determination is made if the delay timer 318 has operated for a time period greater than a predetermined third calibration value (Cal 3) defining a time period saved in a memory. If the response from the third comparator block 350 is YES, steady state operating conditions are deemed to be present and a set steady state flag signal 352 is generated which triggers a steady state flag 354.

If the response from the third comparator block 350 is NO, steady state operating conditions are not deemed to be present and a first negative signal 356 is generated and forwarded to an OR block 358. Similarly, if the response from the second comparator block 342 is NO, a second negative signal 360 is forwarded to the OR block 358. In addition, if the response from the first comparator block 336 is NO, a third negative signal 364 is forwarded to the OR block 358. The OR block 358 also receives negative signals from further comparator blocks discussed below. Any negative signal received in the OR block 358 results in a retention command 362 which commands that previous or present system variable values be retained.

A steady state flag is cleared under the following conditions. In a fourth comparator block 366 a determination is made if the filtered absolute error 310 signal is greater than a predetermined fourth calibration value (Cal 4) saved in a memory. If the response from the fourth comparator block 366 is YES, a first positive signal 368 is forwarded to an OR block 370. The OR block 370 is also in communication with a fifth comparator block 372. In the fifth comparator block 372 a determination is made if the commanded or axle torque requested Ta_r 308 signal is less than or equal to a predetermined fifth calibration value (Cal 5) saved in a memory. If the response from the second comparator block 342 is YES, a second positive signal 374 is forwarded to the OR block 370. Any one of the first or second positive signals 368 or 374 received in the OR block 370 generates a clear steady state flag signal 376.

If the response from the fourth comparator block 366 is NO, steady state operating conditions are not deemed to be present and a fourth negative signal 378 is generated and forwarded to the OR block 358. Similarly, if the response from the fifth comparator block 372 is NO, a fifth negative signal 380 is forwarded to the OR block 358. As noted above any negative signal received in the OR block 358 results in a retention command 362 which commands that previous or present system variable values be retained.

To summarize the above, the following equations can be also be used:

If: filt abs err 310≤(Cal 1)&& Tₐᵣ≥(Cal 2)&& Timer≥(Cal 3)→SS=TRUE (17)

ELSE: IF filt abs err 310≥(Cal 4) OR Tₐᵣ≤(Cal 5)→SS=FALSE (18)

### Where:

Driver axle torque request (commanded): Tₐᵣ

Actual axle torque: Tₐ

(Cal 1) . . . (Cal 5)=calibration values

Timer starts when filt abs err 310≥(Cal 1) && Tₐᵣ≥(Cal 2)

The terms controller, control module, module, control, control unit, processor and similar terms refer to any one or various combinations of Application Specific Integrated Circuit(s) (ASIC), electronic circuit(s), central processing unit(s), e.g., microprocessor(s) and associated non-transitory memory component in the form of memory and storage devices (read only, programmable read only, random access, hard drive, etc.). The non-transitory memory component may be capable of storing machine readable instructions in the form of one or more software or firmware programs or routines, combinational logic circuit(s), input/output circuit(s) and devices, signal conditioning and buffer circuitry and other components that can be accessed by one or more processors to provide a described functionality.

Input/output circuit(s) and devices include analog/digital converters and related devices that monitor inputs from sensors, with such inputs monitored at a preset sampling frequency or in response to a triggering event. Software, firmware, programs, instructions, control routines, code, algorithms and similar terms can include any controller-executable instruction sets including calibrations and look-up tables. Each controller executes control routine(s) to provide desired functions, including monitoring inputs from sensing devices and other networked controllers and executing control and diagnostic instructions to control operation of actuators. Routines may be executed at regular intervals, for example each 100 microseconds during ongoing operation. Alternatively, routines may be executed in response to occurrence of a triggering event.

Communication between controllers, and communication between controllers, actuators and/or sensors may be accomplished using a direct wired link, a networked communication bus link, a wireless link or any another suitable communication link. Communication includes exchanging data signals in any suitable form, including, for example, electrical signals via a conductive medium, electromagnetic signals via air, optical signals via optical waveguides, and the like.

Data signals may include signals representing inputs from sensors, signals representing actuator commands, and communication signals between controllers. The term ‘model’ refers to a processor-based or processor-executable code and associated calibration that simulates a physical existence of a device or a physical process. As used herein, the terms ‘dynamic’ and ‘dynamically’ describe steps or processes that are executed in real-time and are characterized by monitoring or otherwise determining states of parameters and regularly or periodically updating the states of the parameters during execution of a routine or between iterations of execution of the routine.

The control system 100 may be configured to execute each of the steps of a method, as defined in the claims. Thus, the entire description with respect to FIGS. 1-9 may be applied by the control system 100 to effectuate the method, as claimed. Furthermore, the control system 100 may be or include a controller that includes a number of control logics that are configured to execute the steps of the method.

The controller(s) of the control system 100 may include a computer-readable medium (also referred to as a processor-readable medium), including any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which may constitute a main memory. Such instructions may be transmitted by one or more transmission media, including coaxial cables, copper wire and fiber optics, including the wires that comprise a system bus coupled to a processor of a computer. Some forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Look-up tables, databases, data repositories, memory, or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store may be included within a computing device employing a computer operating system such as one of those mentioned above, and may be accessed via a network in any one or more of a variety of manners. A file system may be accessible from a computer operating system, and may include files stored in various formats. An RDBMS may employ the Structured Query Language (SQL) in addition to a language for creating, storing, editing, and executing stored procedures, such as the PL/SQL language mentioned above.

A method for controlling a propulsion system of a motor vehicle of the present disclosure offers several advantages. These include provision of a steady state control system which eliminates torque oscillations and sets a steady state flag to fix system variables allowing the MPC system to minimize or cease torque control optimization and to maximize fuel economy during periods of steady state operation.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for controlling a propulsion system of a motor vehicle, the method comprising:
performing a steady state control enable function to identify when steady state operating conditions are present including:
determining a commanded axle torque;
obtaining a measured actual axle torque; and
identifying when the commanded axle torque is substantially equal to the measured actual axle torque and outputting a signal defining steady state operating conditions are present; and
optimizing fuel economy by constraining program variables for the commanded axle torque to closely follow a reference axle torque when the commanded actual axle torque minus the reference axle torque is less than a calibrated value.

2. The method for controlling a propulsion system of a motor vehicle of claim 1, further including:
directing the signal output from the control enable function to each of an integral action calculator and a Ym filter; and
performing an integral action calculation to identify an axle torque integral action.

3. The method for controlling a propulsion system of a motor vehicle of claim 2, wherein performing the integral action includes:
calculating an absolute value of a difference obtained by subtracting the measured actual axle torque from the commanded axle torque;
filtering the absolute value to minimize signal deviations;
performing a hysteresis evaluation of the filtered absolute value; and
comparing an output from the hysteresis evaluation to a predetermined calibration limit range saved in a memory to determine if the commanded axle torque is within a calibration limit range.

4. The method for controlling a propulsion system of a motor vehicle of claim 3, further including initiating a delay timer if the commanded axle torque is within the predetermined calibrated limit range.

5. The method for controlling a propulsion system of a motor vehicle of claim 2, wherein the integral action calculator performs the following steps:
subtracting an axle torque reference value from the commanded axle torque to compute an error value;
multiplying the error value together with a sampling time value to obtain a product; and
adding the product to a previous value of the integral action to obtain a sum.

6. The method for controlling a propulsion system of a motor vehicle of claim 5, further including passing the sum through a limiter to identify each of an axle torque maximum limit and an axle torque minimum limit.

7. The method for controlling a propulsion system of a motor vehicle of claim 6, further including entering the axle torque maximum limit and the axle torque minimum limit into an integral action enable switch to generate an axle torque integral action command.

8. The method for controlling a propulsion system of a motor vehicle of claim 2, further including applying an output of the Ym filter to modify tracked values including a measured fuel consumption rate, an axle torque measured, a measured transmission ratio and a measured engine output torque.

9. The method for controlling a propulsion system of a motor vehicle of claim 1, further including the steps of:
subtracting the measured actual axle torque from the commanded axle torque to determine an absolute error;
passing an absolute error signal through a low-pass filter to filter predetermined deviations from the signal;
determining if the absolute error signal is less than a predetermined first calibration value;
determining if the commanded axle torque signal is greater than a predetermined second calibration value; and
initiating a delay timer if both the absolute error signal is less than the predetermined first calibration value and if the commanded axle torque signal is greater than the predetermined second calibration value.

10. The method for controlling a propulsion system of a motor vehicle of claim 9, further including:
determining if the delay timer has operated for a time period greater than a predetermined third calibration value; and
setting a steady state flag if the delay timer has operated for the time period greater than the predetermined third calibration value.

11. A method for controlling a propulsion system of a motor vehicle, the method comprising:
performing a control enable function including:
determining a commanded axle torque;
obtaining a measured actual axle torque;
calculating an absolute value of a difference obtained by subtracting the measured actual axle torque from the commanded axle torque;
filtering the absolute value to minimize signal deviations;
performing a hysteresis evaluation of the filtered absolute value;
comparing an output from the hysteresis evaluation to a predetermined calibration limit range saved in a memory to determine if the commanded axle torque is within a calibration limit range; and
initiating a delay timer if the commanded axle torque is within the predetermined calibrated limit range;
directing a signal output from the control enable function to each of an integral action calculator and a Ym filter; and
outputting an integral action range enable command after a predetermined time period.

12. The method for controlling a propulsion system of a motor vehicle of claim 11, further including performing the control enable function using the following set of equations:
Tₐₑ(k)=|Tₐᵣ(k)−Tₐ(k)|; and
Tₐₑ(k)=Tₐₑ(k−1)+α{Tₐₑ(k)−Tₐₑ(k−1)}
where:
Tₐᵣ=Driver axle torque request;
Tₐ=Actual axle torque;
Tₐₑ=Axle torque absolute error;
α=Low-pass filter coefficient; and
k=Discrete-time step.

13. The method for controlling a propulsion system of a motor vehicle of claim 12, further including performing the control enable function using the following additional set of equations:
IF: {Tₐₑ(k)<=LSP&& Tₐᵣ(k)>=Aᵤ&&DT(k)>=t_{d}}→I_{E}(k)=1;
ELSEIF: {Tₐₑ(k)>=RSP∥Tₐᵣ(k)<=Aₗ}→I_{E}(k)=0; and
ELSE:I_{E}(k)=I_{E}(k−1)
where:
Tₐᵣ=Driver axle torque request;
Tₐₑ=Axle torque absolute error;
RSP=Right-shift point;
LSP=Left-shift point;
Aᵤ=Axle torque upper limit;
Aₗ=Axle torque lower limit;
I_{E}=Integral action enable;
k=Discrete-time step; and
DT=turn-on delay timer.

14. The method for controlling a propulsion system of a motor vehicle of claim 11, wherein the integral action calculator performs an integral action using the following set of equations:
Tₑ(k)=Tₐᵣ(k)−Tₐ(k);
Tᵢₐ(k)=Tₑ(k)×Δk+Tᵢₐ(k−1); and
Tᵢₐₘᵢₙ<=Tᵢₐ(k)<=Tᵢₐₘₐₓ
where:
Tₐᵣ=Driver axle torque request;
Tₐ=Actual axle torque;
Tₑ=Axle torque error;
k=Discrete-time step;
Δk=Sample time;
Tᵢₐ=Axle torque integral action;
Tᵢₐₘᵢₙ-Integral action minimum
Tᵢₐₘₐₓ=Integral action maximum.

15. The method for controlling a propulsion system of a motor vehicle of claim 14, wherein the integral action calculator performs the integral action using the following additional set of equations:
IF: {I_{E}(k)=0∥Cₜ}→T_{iaf}(k)=0; and
ELSE: T_{iaf}(k)=Tᵢₐ(k)
where:
I_{E}=Integral action enable;
k=Discrete-time step;
Tᵢₐ=Axle torque integral action;
T_{iaf}=Integral action final; and
Cₜ=Controller transitions.

16. The method for controlling a propulsion system of a motor vehicle of claim 11, further including identifying when the commanded axle torque is substantially equal to the measured actual axle torque defining a steady state operating condition.

17. The method for controlling a propulsion system of a motor vehicle of claim 16, further including setting a steady state flag which fixes system variables directed to torque control changes, thereby ceasing further optimization of torque control allowing fuel economy to be maximized.

18. A system for controlling a propulsion system of a motor vehicle, comprising:
a steady state control enable function identifying when steady state operating conditions are present using each of a commanded axle torque and a measured actual axle torque;
a signal output when the commanded axle torque is substantially equal to the measured actual axle torque;
an integral action calculator and a Ym filter receiving the signal output from the control enable function;
an integral action calculation identifying an axle torque integral action; and
a steady state flag set when steady state operating conditions are present which fixes system variables directed to optimizing torque control, temporarily ceasing further optimization of torque control when the steady state flag is set.

19. The system for controlling a propulsion system of a motor vehicle of claim 18, further including a delay timer initiated if the commanded axle torque is within a predetermined calibrated limit range.

20. The system for controlling a propulsion system of a motor vehicle of claim 19, wherein the steady state flag is also set if the delay timer has operated for a time period greater than a predetermined calibration value.
